(19) United States
(12) Patent Application Publication
(10) Pub. No.: US 2007/0228190 A1
(43) Pub. Date: Oct. 4, 2007

(54) Hand held trigger-operated spray gun

(75) Inventor: Geoffrey A. Tanner, Palatine, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Spraying Systems Co., Wheaton, IL (US)

(21) Appl. No.: 11/729,358

(22) Filed: Mar. 28, 2007

Related U.S. Application Data
(60) Provisional application No. 60/786,890, filed on Mar. 29, 2006.

(51) Int. Cl. B05B 9/01

(52) U.S. Cl. 239/526; 239/583

(57) ABSTRACT

A hand-held trigger operated spray gun for dispersing high pressure liquids. The spray gun includes a control valve assembly which has a first annular coil spring for maintaining a valve seat in position and a second annular coil spring for biasing a valve ball into closing engagement with the valve seat. The valve ball is sized such that the valve seat retaining spring retains it in centered relation to the ball biasing spring even when subjected to high liquid pressure fluctuations. The spray gun further has an improved sealing and trigger lock features.

### CROSS-REFERENCE TO RELATED APPLICATIONS

This patent application claims the benefit of U.S. Provisional Patent Application No. 60/786,890, filed Mar. 29, 2006.

### FIELD OF THE INVENTION

The present invention relates generally to spray guns, and more particularly to hand held and operated spray guns for spraying high pressure liquid flow streams.

### BACKGROUND OF THE INVENTION

Hand held spray guns commonly are used for directing high pressure liquid flow streams, up to 5,000 psi, such as in car washes and in conjunction with use of household and commercial pressure washer systems. Such hand held spray guns often are manufactured by what is referred to in the industry as a “disposable product.” Such disposable spray guns are designed and manufactured for long-term reliable usage without the manufacturer inventorying or supplying replacement parts. In the event of a part failure after normal life of the spray gun, it is customary for the product to be replaced rather than repaired.

While such disposable hand held spray guns are designed for long-term maintenance free usage, they nevertheless have been subject to problems that can impede reliable usage or substantially shortened their intended useful life. Such disposable hand held spray guns, for example, typically are controlled by a trigger actuated ball valve mechanism. Actuation of the spray gun trigger causes a valve stem to move a ball valve away from its valve seat against the biasing force of a coil spring aligned coaxially with the valve seat. The valve seat, in turn, is maintained in a sealed seated position by a separate concentrically-mounted valve-seat retaining coil spring.

High pressure liquid entering the valve chamber of the mechanism upon actuation of the trigger can forcefully move the valve ball out of axial alignment with the valve seat such that upon release of the trigger the ball return spring tends to urge the valve ball laterally to a side, rather than axially into a seated valve closing position. This can either prevent or at least impede reliable closure of the valve. Moreover, the high pressure liquid entering the valve chamber can physically force the valve ball into lodged engagement between coils of the concentrically mounted valve seat retaining coil spring, which can prevent the ball valve from returning to a closed position upon release of the trigger. This not only prevents control of the spray gun, but can create a potentially dangerous condition, if the operator without knowledge of the malfunction, is unable to turn off the spray gun.

To facilitate manufacture and assembly of the valve mechanism into a valve chamber from a rear access opening in the valve body, it is customary following assembly to close the rear access opening by a threaded bolt or stud that is screwed into the access opening, which further retains biasing springs of the mechanism. In order to seal the valve chamber, an o-ring is provided in a retaining groove about a terminal end of the threaded stud, which sealingly engages an internal wall of the spray gun housing adjacent the valve chamber. During assembly, however, it is possible for the o-ring to be scratched or abrased by the sharp internal threads of the access opening as the stud is positioned into the opening for threaded engagement with the housing. Even slight abrasions of the o-ring, which initially can go unnoticed, can cause early failure of the o-ring, and hence, premature failure of the spray gun.

In such high pressure hand held spray guns, it also is customary to have a trigger lock that prevents accidental and potentially dangerous unattended discharge of high pressure/liquid from the spray gun. Such a trigger lock typically is pivotably mounted on the spray gun handle for movement between an extended locking position that prevents actuating movement of the trigger and a retracted or unlocking position that permits trigger actuation. A problem with such trigger locks is that they can be cumbersome to manipulate and locate in a locking position, and hence, simply often are not used by an operator between operating sequences of the spray gun.

### OBJECTS AND SUMMARY OF THE INVENTION

It is an object of the present invention to provide a disposable hand held spray gun that is adapted for more reliable long term usage in the spraying of high pressure liquids.

Another object is to provide a hand held spray gun as characterized above that has a liquid control ball valve mechanism adapted for more stable and reliable operation when spraying high pressure liquids.

A further object is to provide a hand held spray gun of the above kind in which the ball valve is maintained in substantial axial alignment with the valve seat notwithstanding the sudden introduction of high pressure liquid into the valve chamber upon actuation of the spray gun.

Another object is to provide such a hand held spray gun with a ball valve mechanism adapted for preventing forceful engagement of the valve ball between windings of a concentrically mounted valve seat retaining spring as an incident to the introduction of high pressure liquid into the valve chamber.

Yet a further object is to provide a high pressure hand held spray gun of the foregoing type in which the valve chamber of the spray gun has an improved sealing member in which a closure and retaining screw has an annular sealing arrangement that is less susceptible to abrasion or damage during assembly and manufacture of the spray gun.

Another object is to provide a hand held high pressure spray gun of such type which has locking trigger which is adapted for easier and reliable usage by an operator. A related object is to provide such a spray gun trigger lock which tends to encourage locking of the spray gun trigger following usage.

Other objects and advantages of the invention will become apparent upon reading the following detailed description and upon reference to the drawings, in which:

### BRIEF DESCRIPTION OF THE DRAWINGS

FIG. 1 is a perspective of an illustrative spray gun in accordance with the present invention;

FIG. 2 is a vertical section of the spray gun shown in FIG. 1 taken in the plane of line 2-2;

FIG. 3 is an enlarged fragmentary section of the trigger operated flow control valve of the illustrated spray gun;

FIG. 4 is an enlarged fragmentary section of the trigger lock of the illustrated spray gun;

FIG. 5 is a plan view of the trigger lock taken in the plane of line 5-5 in FIG. 4;

FIG. 6 is an enlarged fragmentary view of the mounting hub of the illustrated trigger lock, taken in the plane of line 6-6 in FIG. 5;

FIG. 7 is a fragmentary side elevational view of the trigger of the illustrated spray gun with the trigger lock in an inactive position; and

FIG. 8 is an enlarged view of an end of the trigger lock, taken in the plane of line 8-8 in FIG. 7.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary,, the intention is to cover all modifications, alternative constructions, and equivalents falling within the spirit and scope of the invention.

### DETAILED DESCRIPTION OF THE PREFERRED EMBODIMENT

Referring now more particularly to the drawings, there is shown an illustrated hand held spray gun 10 in accordance with the invention adapted for directing high pressure liquid fluid streams, up to about 5,000 psi. The illustrated spray gun 10 has a pistol configured body or housing 11 having a barrel portion 12 and a depending handle portion 14 disposed at an obtuse angle to the barrel portion 12. The housing 11 in this case is formed by right and left hand housing sections which are secured together by a plurality of fastening screws 15. A liquid supply line 16 is connected to an adapter fitting 18 at a lower or heel end of the handle portion 14 for supplying pressurized liquid to the spray gun 10, such as from a pressure washer or other high liquid pressure supply source.

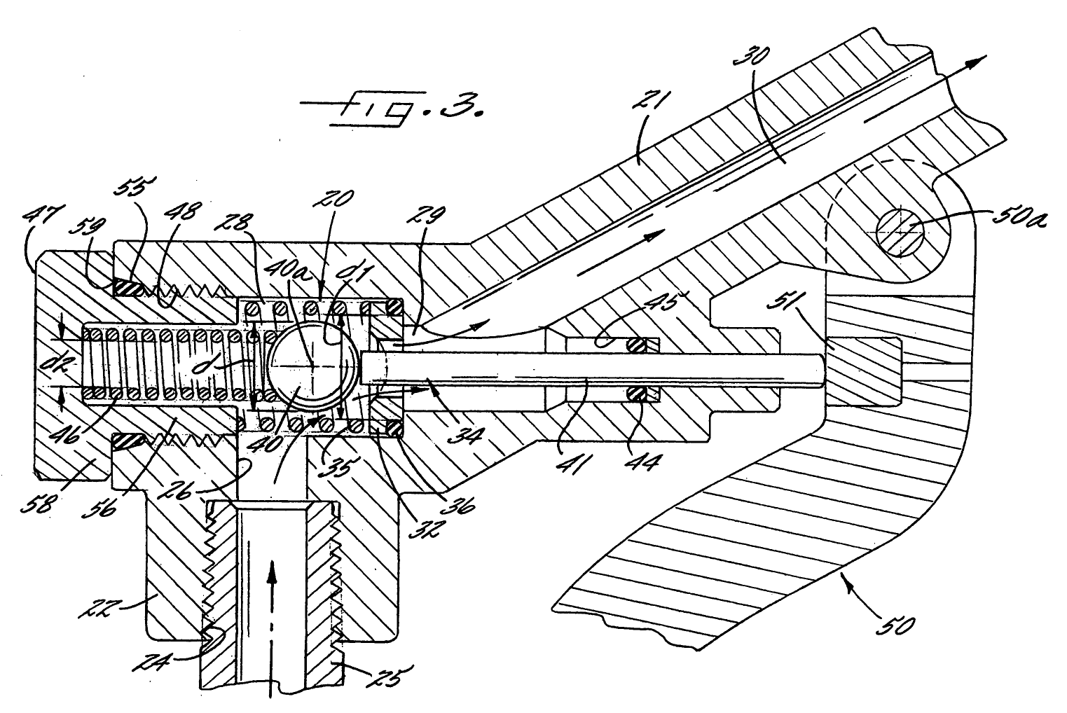

For controlling the flow of pressurized liquid to and through the spray gun 10, a trigger actuated valve assembly 20 (FIGS. 2-3) is captively supported within the housing sections. The valve assembly 20 includes a valve body 21 having a depending portion 22 formed with an internally-threaded inlet port 24 for threadably receiving a liquid supply pipe 25 connected to and communicating with the inlet adapter 18. An inlet port 26 of the body 21 communicates with a valve chamber 28 which in turn communicates with an outlet port 29. The outlet port 29 communicates with an elongated liquid discharge passageway 30 in the valve body, the outlet end of which threadably receives an appropriate spray nozzle 31 from which a discharging flow spray is emitted. The valve assembly 20 includes a valve seat 32 and a valve member 34. The valve seat 32 in this instance is in the form of an angular insert that is maintained in a sealed mounted condition with a downstream end of the valve chamber 28 by a valve seat retaining spring 35 axially biased within the valve chamber 28. An o-ring seal 36 is interposed between a downstream side of the valve seat 32 and the end of the valve chamber 28.

The valve member 34 in this instance has a two-part construction comprising a valve ball 40 and a separate forwardly extending valve stem 41 projecting through an axial bore of the valve seat 32. The valve stem 41 has a terminal end projecting outwardly of the valve body 21, with an o-ring and back up ring pair 44 mounted in a counter bore 45 of the valve body 21 for effecting a sliding seal about the valve stem 41. The valve member 34 is biased toward a valve closing position with the ball 40 seated against the seat 32 by a ball spring 46 interposed between the valve ball 40 and a counter bore in a retaining screw 47 secured within an internally threaded bore 48 leading to the valve chamber 28.

In order to move the valve member 34 between its closed position in a seated engagement with the valve seat 32 and an open position (FIG. 3) that permits communication of high pressure liquid through the inlet port 26, valve chamber 28 an outlet port 29, a trigger 50 is pivotably mounted at 50a on an underside of the forwardly extending portion of the valve body 21 and has a downwardly extending gripping end that is pivotable by the hand of the user while gripping the handle portion 14 of the gun. The trigger 50 in this case carries a striker pin 51 for engagement by the protruding end of the valve stem 41. Upon release of the trigger 50 during operation of the gun, the ball spring 46 and the pressure acting against the valve ball 40 will urge the valve ball toward and into engagement with the valve seat 32 with the valve stem 41 moving the trigger 50 to the right, as viewed in FIG. 2.

As indicated above, heretofore, the introduction of high pressure liquid into the valve chamber upon actuation of the trigger can cause the valve ball to be forced laterally in the valve chamber and become jammed between coils of the valve seat retaining spring, which can prevent or impede return movement of the valve member to a closing position upon release of the trigger. Moreover, with the valve ball offset in the valve chamber as a result of such lateral movement or jamming, the ball spring can tend to engage a side of the valve of the ball, and further urge the valve ball in a jammed condition, rather than axially move the valve ball to its seated position.

In accordance with the invention, the valve ball has a relatively large diameter in relation to the internal diameter of the valve seat retaining spring such that upon actuation of the spray gun and the introduction of high pressure liquid fluid transversly into the chamber the valve ball is retained by the valve seat retaining spring in substantial axial alignment with the valve seat so that upon release of the actuating trigger the ball spring will reliably return the valve ball to a shut off position. To this end, the valve ball 40 is sized relative to an internal diameter “d1” of the valve seat retaining spring 35 such that even if the high pressure liquid stream should laterally displace the ball 40, the center 40a of the ball is maintained within an internal diameter “d2” of the ball spring 46. As a result, upon release of the trigger 50, the ball spring 46 will still exert a substantially axial force on the valve ball 40 for reliable return and shut off in the valve seat 32, without laterally urging the ball in a direction in which it might jam or stick between coils of the concentrically mounted and surrounding valve seat retaining spring 35. Preferably, the ball 40 has a diameter “d” that is at least ¾ the inner diameter “d1” of the valve seat retaining spring 35.

In carrying out the invention, coils of the valve seat retaining spring 35 have a pitch set such that the spacing between coils of the spring, when installed in the spring gun, are sufficiently small as to prevent the ball 40 from being lodged between the coils by high pressure liquid entering the valve chamber 28. Preferably, the coils of the valve seat retaining spring 35, when installed have a spacing of less than 1/8 the diameter of the ball 40.

In an operative embodiment of the invention, reliable performance consistent with the invention has been achieved with a valve assembly having a valve ball 40 that is 0.3125″ in diameter, a valve seat retaining spring 35 having the following specifications:
Outer Dia.=0.480 in
Inner Dia.=0.378 in
Wire Dia.=0.051 in
Free Length=0.750 in
Installed Length=0.450 in
No of active coils=3.4
No of total coils=5.4
   and a the ball spring 46 having the following specifications;
Outer Dia.=0.300 in
Inner Dia.=0.198 in
Wire Dia.=0.051 in
Free Length=0.875 in
Installed Length=0.775 in
No of active coils=8.1
No of total coils=10.1

In keeping with a further aspect of the invention, the valve mechanism retaining screw 47 has an improved sealing arrangement which is protectively contained from damage during manufacturer and assembly of the spray gun. To this end, an o-ring sealing member 55 is disposed about an upstream end of the threaded shank 56 of the retaining screw adjacent a head 58 of the screw for engaging a tapered sealing surface 59 of the valve body 21 adjacent the outwardly opening end of the threaded access opening 48 of the valve body. It will be appreciated by one skilled in the art by locating the o-ring 55 about the retaining screw in such manner prior to threadedly engaging the retaining screw 47 into the threaded access opening 48 of the valve body, the o-ring sealing member 55 is not moved or positioned over the threads of the opening 48 of the valve body during assembly, and hence is not subjected to possible abrasions that can result from rubbing contact with the threads of the body access opening that can cause premature failure and substantial shortening of the life of the spray gun. Instead, the o-ring 55 can be more easily and assuredly positioned over the threaded shank 56 of the screw prior to assembly with the spray gun without damaging contact with the screw threads.

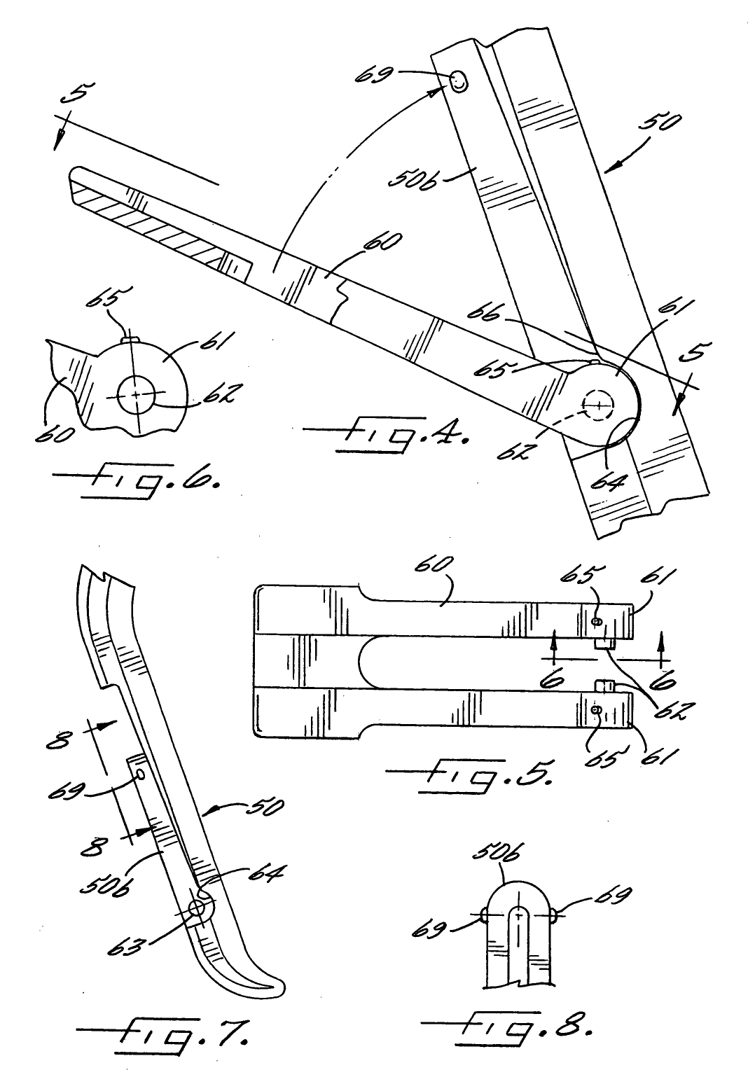

In carrying out a further aspect of the invention, the spray gun has a trigger lock 60 that is adapted for easy and reliable operation, which encourages usage for preventing unintended potentially dangerous discharge from the spray gun. The trigger lock 60 in this case is in the form of an elongated finger pivotably mounted from a lower end of the trigger 50. For pivotably supporting the trigger lock 60, the trigger lock 60 has a pair of axially-spaced lugs 61 with axial mounting pins 62 for positioning in mounting apertures 63 in the trigger 50. The mounting hubs 61 of the trigger lock 60 have generally cylindrical configurations disposed within a semi-circular recess 64 in the trigger 50, as depicted in FIG. 4 and 6.

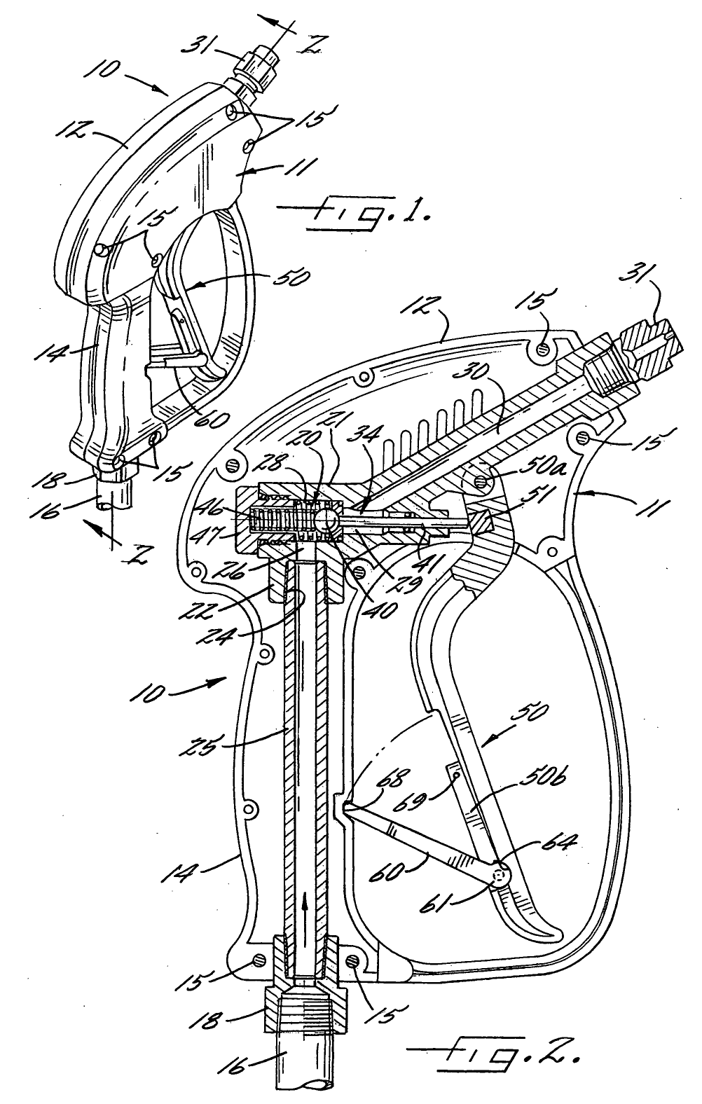

In carrying out the invention, the trigger lock mounting hubs 61 each has a locating nib 65 that is positionable against a peripheral locating corner 66 of the trigger recess 64 for locating and orienting the trigger lock 60, for engagement with a locking recess or aperture 68 (FIG. 2) in the spray gun housing. The locating nibs 65 further defines a detent which can be forcefully past over the locating corner 66 of the trigger recess 64 upon further clockwise pivotable movement of the trigger lock 60, as viewed in FIG. 4, into an inactive position adjacent the back side of the trigger as viewed in FIG. 1. For releasably retaining the trigger in such an inactive position, detent nibs 69 are provided on a flange 50b (FIGS. 7 and 8) of the trigger 50 for positively retaining the trigger lock 60 in such position. It will be understood by a person skilled in the art that the trigger lock 60 can be easily moved to and retained in an inactive position during usage of the spray gun and also be easily located in position with the assistance of the locating nib 65 for locking the trigger during periods of non-use of the spray gun for preventing accidental dangerous high pressure discharge from the spray gun.

From the foregoing, it can be seen that the hand held spray gun of the present invention can be manufactured as a disposable product with long term reliable usage in spraying high pressure liquids. The spray gun has a liquid control valve mechanism that is adapted for more stable and reliable operation without jamming as an incident to controlling the flow of high pressure liquids to the valve mechanism. The spray gun further has an improved valve mechanism sealing arrangement and a trigger lock design that encourages safe usage of the spray gun.

1. A spray gun for dispersing pressurized liquids comprising:
a body having a barrel portion and a handle portion depending from said barrel portion, said body having a liquid inlet for connection to a liquid supply and said barrel portion having a discharge end,
a discharge nozzle at said barrel portion discharge end for emitting liquid from said barrel portion in a spray pattern,
a trigger pivotably mounted on said body for selected hand actuating movement while holding said handle portion between a forward deactuating position and a rearward actuating position,
a control valve assembly selectively actuatable in response to movement of said trigger from said forward position to a rearward position,
said control valve assembly including a valve seat defining a liquid flow passage communicating between said liquid inlet and said discharge nozzle and a valve ball,
an elongated annular coil valve seat retaining spring having a predetermined inside diameter for maintaining said valve seat within said valve assembly,
an elongated annular coil valve ball biasing spring having a predetermined inside diameter for biasing said ball valve against said valve seat for closing said valve seat liquid flow passage,
said valve ball being movable against the biasing force of said valve ball biasing spring in response to movement of said trigger from said forward deactuating position to said rearward actuating position,
said valve seat retaining spring being disposed in concentric relation to said valve ball biasing spring, and
said valve ball having a diameter at least ¾ the inside diameter of said valve seat retaining spring.

2. The spray gun of claim 1 in which coils of said valve seat retaining spring have a pitch such that the spacing between coils of the valve seat retaining spring are sufficiently small to prevent the valve ball from being lodged between the coils by high pressure liquid entering the valve assembly.

3. The spray gun of claim 2 in which the coils of said valve seat retaining spring have a spacing of less than ⅛ the diameter of the valve ball.

4. A spray gun for dispersing pressurized liquids comprising:
a body having a barrel portion and a handle portion depending from said barrel portion, said body having a liquid inlet for connection to a liquid supply and said barrel portion having a discharge end,
a discharge nozzle at said barrel portion discharge end for emitting liquid from said barrel portion in a spray pattern,
a trigger pivotably mounted on said body for selected hand actuating movement while holding said handle portion between a forward deactuating position and a rearward actuating position,
a control valve assembly selectively actuatable in response to movement of said trigger from said forward position to a rearward position,
said control valve assembly having a valve chamber communicating with said liquid inlet and including a valve seat defining a liquid flow passageway communicating between said valve chamber and said liquid discharge nozzle and a valve ball within said valve chamber for movement relative to said valve seat,
an elongated annular coil valve seat retaining spring having a predetermined inside diameter for maintaining said valve seat within said valve assembly,
an elongated annular coil valve ball biasing spring having a predetermined inside diameter less than said valve seat retaining spring for biasing said valve ball against said valve seat for closing said valve seat liquid flow passage,
said valve ball being movable against the biasing force of said ball spring in response to movement of said trigger from said forward deactuating position to said rearward actuating position,
said valve seat retaining spring being disposed in concentric relation to said valve ball biasing spring,
said valve ball biasing spring having smaller inside diameter than said valve seat retaining spring, and
said valve ball having a relatively large diameter in relation to the inside diameter of said valve seat retaining spring such that upon introduction of high pressure liquid into said chamber the valve ball is retained by the valve seat retaining with its center in aligned relation to the inside diameter of the valve ball biasing spring.

5. The spray gun of claim 4 in which said valve ball has a diameter of at least ³/4 the inside diameter of said valve seat retaining spring.

6. The spray gun of claim 4 in which said coils of said valve seat retaining spring have a spacing of at least ⅛ the diameter of said valve ball.

7. The spray gun of claim 4 in which said valve ball biasing spring has an inside diameter of at least ½ the inside diameter of said valve seat retaining spring.

8. A spray gun for dispersing pressurized liquids comprising:
a body having a barrel portion and a handle portion depending from said barrel portion, said body having a liquid inlet for connection to a liquid supply and said barrel portion having a discharge end,
a discharge nozzle at said barrel portion discharge end for emitting liquid from said barrel portion in a spray pattern,
a trigger pivotably mounted on said body for selected hand actuating movement while holding said handle portion between a forward deactuating position and a rearward actuating position,
a control valve assembly selectively actuatable in response to movement of said trigger from said forward position to a rearward position,
said control valve assembly having a valve chamber communicating with said liquid inlet and including a valve seat defining a liquid flow passageway communicating between said valve chamber and said liquid discharge nozzle and a valve ball within said valve chamber for movement relative to said valve seat,
an elongated annular coil valve ball biasing spring for biasing said valve ball against said valve seat for closing said valve seat liquid flow passage,
said valve ball being movable against the biasing force of said ball spring in response to movement of said trigger from said forward deactuating position to said rearward actuating position,
said valve ball biasing spring being interposed between said valve ball and a retaining screw engagably held within a threaded bore of said valve assembly in axial alignment with said annular coil valve ball biasing spring and said valve seat liquid flow passage,
said retaining screw having a threaded shank and an enlarged head, and
an annular sealing member disposed about said shank adjacent said head in interposed relation between said head and an outer wall surface of said valve assembly.

9. The spray gun of claim 8 in which said annular sealing member is interposed between said retaining screw head and an outwardly tapered sealing surface of the outer valve assembly wall.

10. The spray gun of claim 8 in which said retaining screw shank is formed with a counter bore in an outer end thereof which receives one axial end of said elongated valve ball biasing spring.

11. A spray gun for dispersing pressurized liquids comprising:
a body having a barrel portion and a handle portion depending from said barrel portion, said body having a liquid inlet for connection to a liquid supply and said barrel portion having a discharge end,
a discharge nozzle at said barrel portion discharge end for emitting liquid from said barrel portion in a spray pattern,
a trigger pivotably mounted on said body for selected hand actuating movement while holding said handle portion between a forward deactuating position and a rearward actuating position,
a control valve assembly selectively actuatable in response to movement of said trigger from said forward position to a rearward position,
said control valve assembly having a valve chamber communicating with said liquid inlet and including a valve seat defining a liquid flow passageway communicating between said valve chamber and said liquid discharge nozzle and a valve ball within said valve chamber for movement relative to said valve seat,
an elongated annular coil valve ball biasing spring for biasing said valve ball against said valve seat for closing said valve seat liquid flow passage,
said valve ball being movable against the biasing force of said ball spring in response to movement of said trigger from said forward deactuating position to said rearward actuating position,
an elongated trigger lock member supported on said trigger for pivotable movement between an inactive position adjacent said trigger and an active position in outwardly pivoted relation to said trigger,
said body being formed with a recess for receiving a free end of said trigger lock member when said trigger is in said deactuating position and said trigger lock member is in said active position, and
said trigger lock member being formed with a locating nib engageable with said trigger for positioning the trigger lock member in predetermined relation to the trigger lock member receiving recess when said trigger is in said deactuated position.

12. The spray gun of claim 11 in which said trigger is pivotably mounted in depending relation to said handle portion, and said trigger lock member is pivotably mounted adjacent a lower end of said trigger.

13. The spray gun of claim 11 in which said trigger lock member has a mounting end formed with a cylindrical configured hub that is disposed within a circular recess and said trigger, and said locating nib extends radially from said cylindrical hub.

14. The spray gun of claim 13 in which locating nib is engageable with a locating corner of the trigger defined by said recess.

15. The spray gun of claim 11 in which said locating nib defines a detent that can be forcefully passed beyond said locating corner into said recess upon pivotable movement of said trigger to an inactive position adjacent a side of said trigger frictionally retaining the trigger in its active position.

16. The spray gun of claim 11 in which said trigger has at least one detent nib that is engageable with said trigger lock member upon pivoting to said inactive position for positively but releasably retaining the trigger in the inactive position.
